(19) United States
(12) Patent Application Publication
(10) Pub. No.: US 2012/0117374 A1
(43) Pub. Date: May 10, 2012

(54) CENTRAL MANAGEMENT COMPUTING SYSTEM

(76) Inventors: Won Ok Kwon, Daejeon (KR); Jae Sung Lee, Seoul (KR); Seong Woon Kim, Chungcheongnam-do (KR)

(21) Appl. No.: 13/384,034

(22) PCT Filed: Oct. 8, 2009
(86) PCT No.: PCT/KR09/05759

§ 371 Date: Jan. 13, 2012

(30) Foreign Application Priority Data
Jul. 15, 2009 (KR) 10-2009-0064639

(51) Int. Cl. G06F 1/26

(52) U.S. Cl. 713/100

(57) ABSTRACT

Provided is a central management computing system. The central management computing system includes a plurality of terminals, and a rack system. The rack system is connected to the plurality of terminals. The rack system includes a rack power supply unit, a plurality of computers, and a switch. The rack power supply unit is mounted in a rack and converts an AC power into a plurality of DC powers to output to a plurality of DC output ports. The plurality of computers are mounted in the rack and receive the DC powers from the DC output ports. The switch is mounted in the rack and dynamically connects the computers to the terminals, respectively.

### TECHNICAL FIELD

The present disclosure relates to a central management computing system, and more particularly, to a central management computing system for solving inefficient space utility that occurs when a plurality of computers are independently operated in respective computing environments, disruption of business due to upgrade/repair of hardware and software, and inefficient power management of the total computing environment.

### BACKGROUND ART

Under a distributed utility computing environment, each computer uses an individual Power Supply Unit (hereinafter, referred to as PSU) inefficiently, causing an electric power loss of about 30%. Hereinafter, detailed description thereof will be made with reference to FIGS. 1 and 2.

FIG. 1 is a block diagram illustrating a related-art power supply system, and FIG. 2 is a block diagram illustrating the power supply system of FIG. 1 in more detail.

Referring to FIG. 1, a related-art power supply system 1 will be briefly described. A high voltage generated in a power station (not shown) is transformed to a voltage of between about 300V and about 600V via a substation 2. Then, the voltage is supplied to a rack 6 via a power delivery switch 3, an Uninterruptible Power Supply (hereinafter, referred to as UPS) 4, and a Power Distribution Unit (hereinafter, referred to as PDU) 5.

Hereinafter, an electric power system for supplying power from the UPS 4 to the rack 6 will be described in more detail with reference to FIG. 5.

The UPS 4 includes an AC/DC converter 7 and a DC/AC converter 8. The UPS 4 receives three-phase power to perform an AC/DC conversion or a DC/AC conversion, outputting high-voltage alternating current that is used in a data center.

The output voltage from the UPS 4 is converted into about 100V AC to about 220V AC via the PDU 5, and supplied to the rack 6 including computers 9_1, 9_2 and 9_n such as a server, a storage, and a switch.

Each of the computers 9_1, 9_2 and 9_3 includes a PSU 13, and a Voltage Regulator Module (hereinafter, referred to as VRM) 14 therein. The PSU 13 includes an AC/DC converter 11 and a DC/DC converter 12 to convert about 100V AC to about 220V AC supplied from the PDU 5 into DC such as +12V, −12V, +5V, and +3.3V that is used in various electronic components (not shown) of the computers 9_1, 9_2 and 9_3, and supply the DC voltages to the VRM 14. The VRM 14 converts the DC voltages from the PSU 13 into DC voltages that are used in each electronic component (not shown).

As described above, at least three AC/DC or DC/AC conversions and one DC/DC conversion are performed in a related-art, which cause an electric power loss. The electric power loss is chiefly caused by the PSU 13 mounted in each computer.

That is, under a related-art utility computing environment, computers 9_1, 9_2 and 9_3 include individual PSUs 13, which receive about 100V AC to about 200V AC and perform AC/DC conversions and a DC/DC conversion during the process of generating various DCs for the computers 9_1, 9_2 and 9_3, resulting in a significant power loss.

Also, inefficient power control using an Advanced Configuration and Power Interface (ACPI) may cause a significant power loss even when a computer is not used. In the case of a general PC or a volume server, electric power duplexing is not provided. Accordingly, remote electric power monitoring and electric power control are impossible.

Furthermore, under a distributed utility computing environment, tasks cannot be performed when a failure occurs in one's own computing hardware. Also, a system conversion such as conversion from low-performance computing to high-performance computing, or conversion between Window and Linux operating systems is difficult to easily achieve. Furthermore, tasks such as program installations and repairs are not easy to perform, which makes maintenance of hardware difficult.

### DISCLOSURE

### Technical Problem

Therefore, an object of the present invention is to provide a central management computer system to solve inefficient space utility that occurs when a plurality of computers are independently operated in respective computing environments, disruption of business due to upgrade/repair of hardware and software, and inefficient power management of the total computing environment.

The object of the present invention should not be construed as restricted to the aforementioned object. Rather, other objects undescribed herein will be obviously understood by those skilled in the art with reference to the following descriptions.

### Technical Solution

To achieve these and other advantages and in accordance with the purpose(s) of the present invention as embodied and broadly described herein, a central management computing system in accordance with an aspect of the present invention includes: a plurality of terminals; and a rack system connected to the plurality of terminals, the rack system includes: a rack power supply unit mounted in a rack and converting an AC power into a plurality of DC powers to output to a plurality of DC output ports; a plurality of computers mounted in the rack and receiving the DC powers from the DC output ports; and a switch mounted in the rack and dynamically connecting the computers to the terminals, respectively.

Detailed descriptions of other embodiments will fall within the detailed description of the present invention and the accompanying drawings.

### Advantageous Effects

Embodiments can reduce the power consumption due to highly-efficient power usage by using a rack built-in DC power supply unit, performs an efficient power control by using ACPI power management, and monitor the power consumption and power abnormality.

Also, embodiments can connect a plurality of users dynamically to various computing environments, and correct the continuity of business by connecting the plurality of users to other computing environments when failure occurs on the current computer.

Furthermore, since all computers are concentrated on a rack, maintenance is convenient when failure occurs on hardware.

### DESCRIPTION OF DRAWINGS

FIG. 1 is a block diagram illustrating a related-art power supply system.

FIG. 2 is a block diagram illustrating the power supply system of FIG. 1 in more detail.

FIG. 3 is a diagram illustrating a central management computing system according to an embodiment.

FIG. 4 is a diagram illustrating an exemplary rack system.

FIG. 5 is a diagram illustrating a switch of FIG. 3.

FIG. 6 is a diagram illustrating RPSU of FIG. 1 and PDB mounted in each computer.

### BEST MODE

Advantages and features of the present disclosure, and a method of accomplishing them will be apparent with reference to embodiments which will be described in detail below together with the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the present specification, the same reference numeral indicates like element. Also, if one element is referred to as “connected to” another element, it may be a form of direct connection or coupling, or includes possible interposition of other elements. “And/or” includes each of items described herein, and one or more combination thereof. Terms used in the present specification are merely used for describing specific embodiments, which do not intend to limit the present invention. As far as singular expression clearly denotes a different meaning in context, it includes plural expression. In the present specification, it is understood that terms “comprises”, “comprising”, “includes” or “has” intend to indicate the existence of features, numerals, steps, operations, elements and components described in the present specification or the existence of the combination of these, and do not exclude the existence of one or more other features, numerals, steps, operations, elements and components or the existence of the combination of these or additional possibility beforehand.

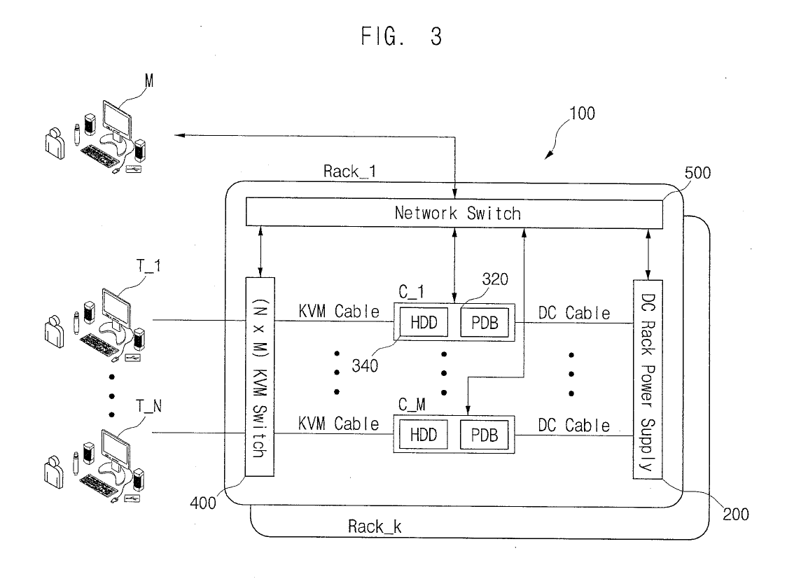

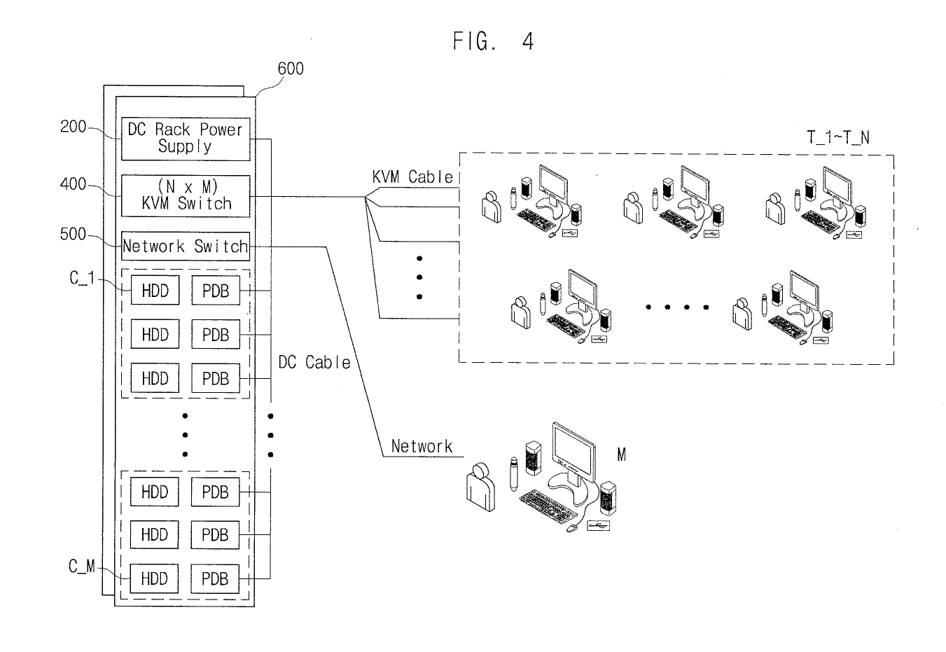

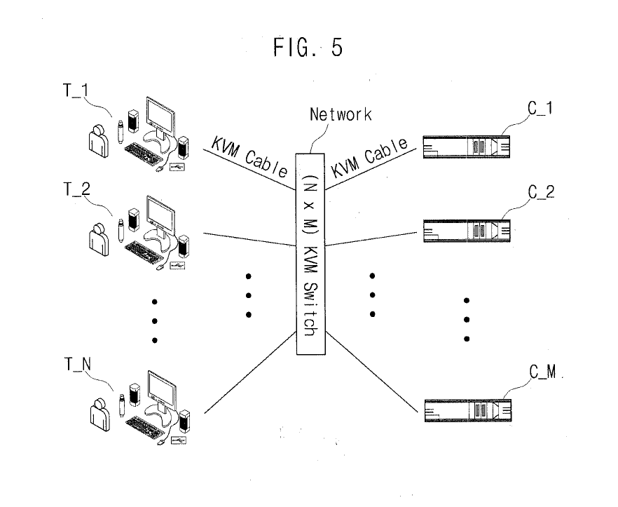

Hereinafter, a central management computing system will be described in detail with reference to FIGS. 3 through 5. FIG. 3 is a diagram illustrating a central management computing system according to an embodiment. FIG. 4 is a diagram illustrating an exemplary rack system. FIG. 5 is a diagram illustrating a switch of FIG. 3.

Referring to FIG. 3, a central management computing system includes a plurality of terminals T_1 through T_N, and a rack system 100.

Each of terminals T_1 through T_N includes a display device such as LCD, PDP, and CRT, and a user interface device binding including a keyboard, a mouse, a speaker, a microphone, a USB port. Here, the display device refers to a device that receives an image signal through composite cables, S-VIDEO cables, component cables, D-SUB cables (or VGA cables), DVI cables, HDMI cables, and other analog or digital image-related cables, and outputs the image signal on a display panel. The mouse refers to a device that communicates with computers C_1 through C_M through a PS2 or USB port. The keyboard refers to a device that communicates with the computers C_1 through C_M through a PS2 or USB port. The speaker refers to a device that is connected to the computers C_1 through C_M through various audio cables such as RCA, OFC and the like. The USB port is a connection means annexed to each computer C_1 through C_M. The USB port may support the USB communication protocols and be provided in the form of a single cable port or a USB hub for providing a plurality of ports. Also, the USB port/hub may be implemented in an incorporated form into a side surface or a front surface of a monitor or other terminal T_1 through T_N components such as keyboard and the like. A USB mouse or keyboard is connected to a USB port to configure the terminals T_1 through T_N. Various USB annex devices such as a USB PC camera is similarly connected to the USB port to configure the terminals T_1 through T_N.

These terminals T_{——}1 through T_N are mutually connected to the computers C_1 through C_M of the rack system 100 dynamically.

The rack system 100 includes a rack power supply unit (RPSU) 200 mounted onto a rack, a plurality of computers C_1 through C_M mounted onto the rack, a switch 400 mounted onto the rack, and a network switch 500. FIG. 4 illustrates the RPSU 200, the plurality of computers C_1 through C_M, the switch 400, and the network switch 500, which are mounted onto the rack.

The RPSU 200 converts a received AC power into a plurality of DC powers and outputs the DC power though a plurality of DC output ports. The DC powers outputted through the DC output port are provided to each computer C_1 through C_M.

A plurality of computers C_1 through C_M include a HDD 340 having a hotplug form, which allows the computers C_1 through C_M to be easily recovered from a failure by replacing the HDD 340. Also, each computer C_1 through C_M includes a Power Distribute Board (PDB) 320 that receives a DC power from the RPSU 200 and supplies the DC power to each power load of the computers C_1 through C_M by raising or lowering the DC power or as it is. An ACPI power management agent may be installed in each computer C_1 through C_M, which may be controlled by an ACPI management program of the following management computer M. An operating system such as Window and Linux and hardware such as high-performance graphic hardware, general office hardware, high-performance processing hardware may be installed in the computers C_1 through C_M according to their purposes.

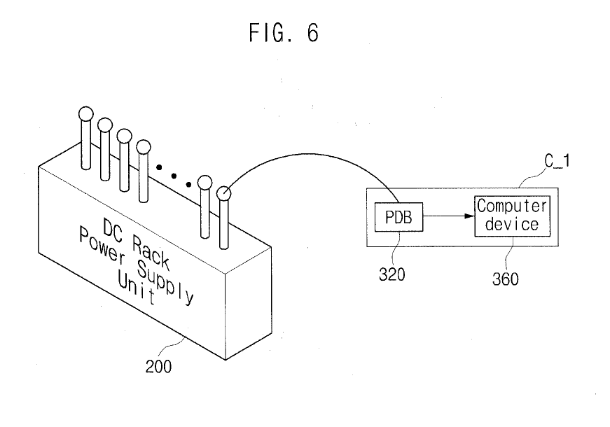

The rack system 100 may omit PSU (refers to 13 of FIG. 13) in the computers C_1 through C_M through RPSU 200 and PDB 320 mounted in each computers C_1 through C_M. Accordingly, unnecessary multi-step AC/DC conversion may be avoided. For example, a DC voltage of about 10V to about 100V may be directly provided to computers C_1 through C_M, thereby enhancing the power efficiency. Detailed description of the PDB 320 and the RPSU 200 mounted in each computer will be made with reference to FIG. 6.

On the other hand, the switch 400 connects the plurality of terminals T_1 through T_N to the plurality of computers C_1 through C_M. For example, as illustrated in FIG. 5, when the number of the terminals T_1 through T_N is N, and the number of the computers C_1 through C_M is M, the switch 400 having N inputs and M outputs may be an (N×M) KVM switch 400 (hereinafter, referred to as an (N×M) KVM switch 400). Here, KVM is an abbreviation of keyboard, video, and mouse, but further includes an audio, a microphone, and a USB port herein.

That is, the (N×M) KVM switch 400 connects each terminal T_1 through T_N including user interface devices such as a keyboard, a video, a mouse, an audio, a microphone, a USB port to each computer C_1 through C_M dynamically. For example, the first terminal T_1 may be connected the M-th computer C_M, and the N-th terminal T_N may be connected to the first computer C_1. Otherwise, the first terminal T_1 may be connected to the first computer C_1, and the N-th terminal T_N may be connected to the M-th computer C_M. A transmission signal of each terminal T_1 through T_N may be transmitted to each computer C_1 through C_M through the (N×M) KVM switch 400 and the KVM cable. In this case, an amplifier, a repeater, or a buffering circuit may be added, provided that the rack system 100 is far away from the terminals T_1 through T_N.

The management computer M may be connected to the rack system 100 through the network switch 500 by remote, thereby monitoring and controlling the operation of the rack system 100 by remote.

More specifically, the management computer M controls the (N×M) KVM switch 400 through (N×M) KVM switch management software. For example, the management computer M is connected to the (N×M) KVM switch 400 through the network switch 500, thereby monitoring the current connection state between the plurality of terminals T_1 through T_N and the plurality of computers C_1 through C_M.

Also, the connection state between the plurality of terminals T_1 through T_N and the plurality of computers C_1 through C_M may be dynamically changed. The dynamic change of the connection state may be performed for an upgrade or a repair of the connected computers C_1 through C_M, or may be performed for an efficient power usage in consideration of the power consumption. Additionally, the connection state may also be changed the demands of the terminals T_1 through T_N.

The management computer M may be connected to the RPSU 200 through the network switch 500 by RPSU management software, thereby monitoring the power consumption and power abnormality of each computer C_1 through C_M by remote and controlling the power-on/off of each computer C_1 through C_M.

The management computer M may be connected to the RPSU 200 through the network switch 500, thereby monitoring the DC power supplied from each DC output port. The management computer M may be connected to a (N×M) KVM switch 400 through the network switch 500 for optimal power efficiency, thereby changing the connection state between the terminals T_1 through T_N and the computers C_1 through C_M.

The management computer M may set ACPI policies of each computer C_1 through C_M by remote, through ACPI management software. Also, the management computer M may be connected to the computers C_1 through C_M through the network switch 500, thereby controlling the power saving mode of the computers C_1 through CM according to the set policies.

The management computer M may be connected to the computers C_1 through C_M through the network switch 500, thereby calculating the usage time and the usage fee of the computers C_1 through C_M, monitoring the programs that are executed on the computers C_1 through C_M, and restricting the use of the programs according to the policies.

A user may be connected to the management computer M through the network switch 500, thereby informing the management computer M of failure that may occur in using the computers C_1 through C_M.

Thus, by concentrating the computers C_1 through C_M on the rack through the (N×M) KVM switch 400 and installing user interface devices such as keyboards, videos, mice, audios, microphones, and USB ports in each terminals T_1 through T_N, space may be efficiently utilized. Also, when one of the computers C_1 through C_M is upgraded or repaired, each terminal T_1 through T_N is dynamically connected to other computers C_1 through C_M, thereby assuring the continuity of jobs from a user's point of view. Also, the connection state between the terminals T_1 through T_N and the computers C_1 through C_M may be dynamically changed by monitoring the connection state. The convenience and efficiency of the management may be enhanced by monitoring the power consumption or power abnormality of each computer C_1 through C_M and controlling the power-on/off and power saving mode of each computer C_1 through C_M.

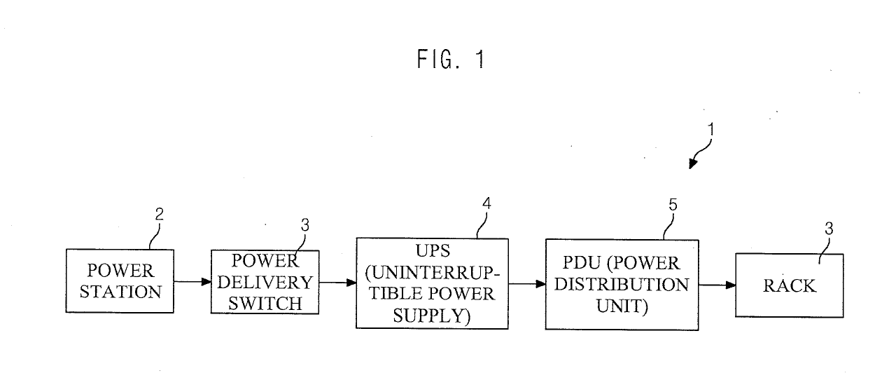

Hereinafter, a RPSU 200 mounted in the rack and a PDB 320 mounted in each computer C_1 through C_M are described in detail with reference to FIG. 6. FIG. 6 is a diagram illustrating RPSU of FIG. 1 and PDB mounted in each computer.

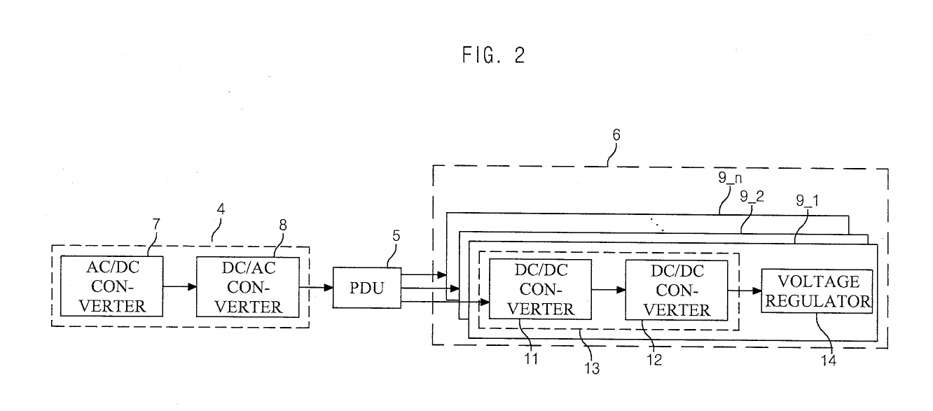

The RPSU 200 converts an AC power, for example an AC voltage and/or an AC current received from the power distribution unit (refer to 5 in FIG. 2) into a DC power, for example a DC voltage and/or a DC current, and provides the DC power to each computer C_1 through a plurality of DC output ports. The RPSU 200 may be mounted in every rack system 100, taking charge of all consumption power that is consumed in the rack system 100.

Each computer C_1 includes the PDB 320. The PDB 320 DC/DC-converts the DC power from the RPSU 200, for example, a 10V through 100V DC voltage into voltages necessary for the computer C_1, for example, 12V, 5V, and 3.3V DC voltage that is required to operate the power load in the computer C_1.

If necessary, the computer C_1 may further include a voltage regulator (not shown) that varies the DC voltages outputted from the PDB 320.

The RPSU 200 and PDB 320 may allow the PSU (refer to 13 in FIG. 1) to be omitted in the computers C_1 through C_M. Accordingly, unnecessary multi-step AC/DC conversion may be omitted. That is, 10V through 100V DC voltage may be directly provided to computers C_1 through C_M, thereby enhancing power efficiency.

The management computer M may manage the power consumption and power abnormality of each computer C_1 through C_M by monitoring the DC power supplied from each DC output port. The management computer M may control the power-on/off of each computer C_1 through C_M by controlling the RPSU 200.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A central management computing system comprising:
a plurality of terminals; and
a rack system connected to the plurality of terminals, the rack system comprising:
a rack power supply unit mounted in a rack and converting an AC power into a plurality of DC powers to output to a plurality of DC output ports;
a plurality of computers mounted in the rack and receiving the DC powers from the DC output ports; and
a switch mounted in the rack and dynamically connecting the computers to the terminals, respectively.

2. The central management computing system of claim 1, further comprising a remote management computer connected to the rack system through a network switch mounted in the rack.

3. The central management computing system of claim 2, wherein the management computer is connected to the switch through the network switch, and controls the switch to dynamically connect the computers to the terminals, respectively.

4. The central management computing system of claim 2, wherein the management computer monitors current connection states between the computers and the terminals through the switch, respectively.

5. The central management computing system of claim 2, wherein the management computer is connected to the rack power supply unit through the network switch to monitor power consumption and power abnormality of the computers and control power-on/off of the computers.

6. The central management computing system of claim 2, wherein the management computer is connected to the computers through the network switch to control power-saving modes of the computers according to ACPI policies for the computers.

7. The central management computing system of claim 2, wherein the management computer is connected to the computers to calculate the usage time and usage fee of the computers and monitor at least one program that is executed on the computers, respectively.

8. The central management computing system of claim 2, wherein, when failure occurs in using the connected computers, each of the terminals informs the management computer of the failure through the network switch.

9. The central management computing system of claim 1, wherein the terminal comprises at least one of a USB port, a microphone, an audio interface, a keyboard, a video interface, and a mouse.

10. The central management computing system of claim 1, wherein the computers comprise power distribution boards, respectively, that reduce or increase the DC power supplied from the DC output ports to provide to power loads of the computers.
